(19) United States
(12) Patent Application Publication
(10) Pub. No.: US 2007/0124151 A1
(43) Pub. Date: May 31, 2007

(54) Encoded multi-key index data stream structure

(76) Inventor: Hyoseop Shin, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 10/506,031

(22) PCT Filed: Jun. 27, 2003
(86) PCT No.: PCT/KR03/01262

§ 371 Date: Jan. 16, 2007

(30) Foreign Application Priority Data
Jul. 23, 2002 (KR) 10-2002-0043097

(51) Int. Cl. G06Q 99/00

(52) U.S. Cl. 705/1

(57) ABSTRACT

Disclosed is an index data stream structure for digital contents metadata containing an encoded multi-key for digital contents metadata defined in the TV-Anytime forum (that is, TVA metadata), thereby allowing a receiver receiving the digital contents metadata to locate the metadata meeting a plurality of conditions, that is, composite conditions, in a prompt and efficient manner, by providing an encoded multi-key of the digital contents metadata. The present invention provides a method of accessing an encoded multi-key indexing in order to provide functions for an efficient location and an access relative to the TVA metadata fragment, thereby allowing the receiver receiving the TVA metadata to search for composite conditions for the TVA metadata in an efficient manner.

### TECHNICAL FIELD

The present invention relates, in general, to an encoded multi-key index data stream structure for locating composite index keys of digital contents metadata and, more particularly, to an index data stream structure containing a fragment of multi-key indices encoded for XML metadata for digital contents defined in the TV-Anytime Forum (hereinafter referred to as “TVA metadata”) so as to allow composite index keys for metadata to be efficiently located when TVA metadata is transported in an independent unit so called a fragment.

### BACKGROUND ART

As well known to those skilled in the art, the TV-Anytime Forum is a civil organization for standardization, established in September 1999. with an aim of developing standards for providing audio and visual related services in a user environment such as a PDR (personal digital recorder) having a high volume storage for personal purpose. To specify, the TV-Anytime Forum is designed to enable all the users to listen and view TV programs in various forms (e.g., existing broadcasting services and on-line interactive services, etc.) in any desired manner and at any desired time on the basis of the personal storage.

The TV-Anytime Forum is carrying the project for standardization by operating several working groups for business models, system, transport interfaces and content referencing, metadata, rights management and protection, etc. With respect to the metadata involved in the present invention, “SP003v1.3 Part B Version 1.3” had been published up to Aug. 2, 2002. In “WD647-Draft SP003v13 Part B” currently in discussion, an encoded multi-key index data stream structure for metadata fragment indexing has been proposed.

The structure comprises:

1. Index list (index_list) section

The index list (index_list) section provides a list of all the multi-keys being transported. Within each index list (index_list) structure is included num_fields so as to enable multi-key indexing as suggested in Table 1.

TABLE 1

| Syntax | No. of Bits | Mnemonic |
|---|---|---|
| index_list( ) { | | |
| for (j=0; j<num_indexes, j++) { ... | | |
| index_descriptor_length | 8 | uimsbf |
| fragment_type | 16 | uimsbf |
| if(fragment_type == 0xffff) { | | |
| fragment_xpath_ptr | 16 | uimsbf |
| } | | |
| num_fields | 8 | uimsbf |
| for(k=0; k<num_fields; k++) { ... | | |
| field_identifier | 16 | uimsbf |
| if(field_identifier == 0xffff) { | | |
| field_xpath_ptr | 16 | uimsbf |
| } | | |
| field_encoding | 16 | uimsbf |
| } | | |
| | 16 | uimsbf |
| index_identifier | 8 | uimsbf |
| } | | |
| } | | |

2. Index section

TABLE 2

| | No. | |
|---|---|---|
| Syntax | of Bits | Mnemonic |
| index( ) { | | |
| overlapping_subindexes | 1 | bslbf |
| single_layer_sub_index | 1 | bslbf |
| reserved | 6 | bslbf |
| fragment_locator_format | 8 | uimsbf |
| for (j=0; j<sub_index_count, j++) { ... | | |
| for(k=0; k<num_fields; k++) { ... | | |
| if (overlapping_subindices == ‘1’ ) { | | |
| low_field_value | 16 | uimsbf |
| } | | |
| high_field_value | 16 | uimsbf |
| } | | |
| sub_index_container | 16 | uimsbf |
| sub_index_identifier | 8 | uimsbf |
| } | | |
| } | | |

3. Multi field sub index(multi_field_sub_index) section

TABLE 3

| | No. | |
|---|---|---|
| | of | |
| Syntax | Bits | Identifier |
| multi_field_sub_index( ) { | | |
| multi_field_header { | | |
| leaf_field | 1 | bslbf |
| multiple_locators | 1 | bslbf |
| reserved | 6 | bslbf |
| } | | |
| multi_field_index_entries { | | |
| for (j=0; j<num_entries; j++) { ... | | |
| if(single_layer_sub_index == ‘0’) { | | |
| multi_layer_sub_index_structure( ) | | |
| } else { | | |
| single_layer_sub_index_structure( ) | | |
| } | | |
| } | | |
| } | | |
| } | | |

In the conventional multi-key index data stream structure, since a fragment or a key have respectively been provided with an encoded value, an Xpath or a method of encoding the same have to be assigned to each index key and any field not belonging to a fragment subject to being indexed cannot be specified with a key. In addition, indexing by means of a synthesized key field not existing as an actual field in the TVA metadata XML document is not possible.

### DISCLOSURE OF THE INVENTION

Accordingly, the present invention has been made keeping in mind the above problems occurring in the prior art, and an object of the present invention is to provide an encoded multi-key index data stream structure useful for locating composite index keys of digital contents metadata.

In order to accomplish the above object, the present invention provides an encoded multi-key index data stream structure of digital contents metadata, wherein a mandatory index list required for the TV-Anytime is specified and a key of the index belonging to the mandatory index list is assigned an encoded value without using an XPath. Therefore, the present invention features that only an encoded value is assigned even when the index key is comprised of several multi fields.

### BEST MODE FOR CARRYING OUT THE INVENTION

Hereinbelow, the present invention will be described in details with reference to the tables below.

A mandatory index list, for illustrative purpose, required for the TV-Anytime will be observed.

An encoding value is assigned to each index according to an index key, in which the encoding value can contain information about a fragment thereof. A multi-key is treated as a composite index key, but a specified multi-key is assigned an encoding value as same as in a single key. 0x0000 may be assigned to an unspecified field so as to index an arbitrary fragment.

TABLE 1

| Fragment Type | Index Key | Value |
|---|---|---|
| Unspecified fragment type | Any field of Schema type TVAIDType | 0x0000 |
| Program Information | @programId | 0x0001 |
| | BasicDescription/Title | 0x0002 |
| | BasicDescription/Keyword | 0x0003 |
| | BasicDescription/Genre | 0x0004 |
| | PersonName -> (FamilyName, | 0x0005 |
| | GivenName) | |
| Group Information | GroupType | 0x0006 |
| | @groupId | 0x0007 |
| OnDemandProgramLocation | | |
| BroadcastEvent | @serviceIDRef | 0x0008 |
| | (@serviceIdRef, PublishedTime, | 0x0009 |
| | EndTime) | |
| Schedule | (@serviceIDRef, start, end) | 0x000A |
| Service Information | @serviceId | 0x000B |
| | ServiceGenre | 0x000C |
| PersonName | @personNameId | 0x000D |
| | (FamilyName, GivenName) | 0x000E |
| OrganisationName | @organisationNameId | 0x000F |
| ProgramReviews | Program/@crid | 0x0010 |
| CSAlias | @alias | 0x0011 |
| ClassificationScheme | Term | 0x0012 |
| Segment Information | ProgramRef/@crid | 0x0013 |
| | @segmentId | 0x0014 |
| | Description/Title | 0x0015 |
| | Description/Keyword | 0x0016 |
| Segment Group Information | ProgramRef/@crid | 0x0017 |
| | GroupType | 0x0018 |
| | @groupId | 0x0019 |
| | Description/Title | 0x001A |
| | Description/Keyword | 0x001B |
| TVA Reserved | N/A | 0x000E-0x00EF |
| User Private | N/A | 0x00F0-0xFE00 |
| W3C XPath Expression | N/A | 0xFFFF |

Based on the above table, two types of special index keys may be introduced.

(1) Index Key not Contained in a Fragment

Indexing by means of a key field not contained in a concerned fragment is necessary to simplify a query processing of the PDR. In the above table, the ProgramInformation fragment is indexed by use of the person name field contained within the PersonName fragment belonging to CreditsInformation (please note that ProgramInformation may be associated with the PersonName fragment belonging to the CreditsInformation through BasicDescription/CreditsList/PersonNameIDRef). In this case, the ProgramInformation is indexed by (FamilyName, GivenName) located within the PersonName fragment.

(2) Synthesized Index Key

A synthesized index key not existing within a fragment may be used. The synthesized key is composed by a combination of key fields existing within the fragment. For example, it is desirable to provide an index for a multi-key of <serviceId, PublishedTime, EndTime> for a BroadcastEvent fragment, wherein no key field exists for ‘Endtime.’ In this case, ‘EndTime’ may be synthesized by combining ‘PublishedTime’ and ‘PublishedDuration.’

To provide the mandatory index list as described above, the following structures are necessary. In the above indices, the key field XPath or key field encoding is not required.

1. index_list section

TABLE 2

| | No. of | |
|---|---|---|
| Syntax | Bits | Mnemonic |
| Index_list( ) { | | |
| for (J=0; j<num_indexes; j++) { ... | | |
| index_descriptor_length | 8 | uimsbf |
| fragment_type | 16 | uimsbf |
| if(fragment_type == 0xffff) { | | |
| fragment_xpath_ptr | 16 | uimsbf |
| } | | |
| key_identifier | 16 | uimsbf |
| If ( key_identifier == 0xffff ) { ... | | |
| num_fields | 8 | uimsbf |
| for(k=0; k<num_fields; k++) { ... | | |
| field_xpath_ptr | 16 | uimsbf |
| } | | |
| field_encoding | 16 | uimsbf |
| } | | |
| index_container | 16 | uimsbf |
| index_identifier | 8 | uimsbf |
| } | | |
| } | | |

The fields of the index_list structure described above will be described below.

index_descriptor_length: length of each index_descriptor

fragment_type: encoding value of a fragment type

fragment_XPath_ptr: xpath pointer of a fragment not encoded

key_identifier: a value of encoding an index key

num_fields: number of key fields of index keys not encoded

field_xpath_ptr: a xpath pinter of each key field of index keys not encoded

field_encoding: an encoding type of each key field of index keys not encoded

index_container: a container id containing an index structure

index_identifier: an ID of the concerned index structure

The key_index section and multi_field-sub_index section as described above may be of the same as the conventional sections or a part thereof may be modified according to the above list and the index list section.

### INDUSTRIAL APPLICABILITY

As described above, the multi-key index data stream structure according to the present invention provides an encoded value, for which it does not need to separately specify an XPath and an encoding method relative to each index key, thereby decreasing the overhead on the receiver side. In addition, since the field not belonging to a fragment subject to being indexed can be specified with a key, thereby capable of generating a user-centered field.

Although an embodiment of the present invention have been disclosed for illustrative purposes, those skilled in the art will appreciate that various modifications, additions and substitutions are possible, without departing from the scope and spirit of the invention as disclosed in the accompanying claims.

1. An encoded multi-key index data stream structure for locating an composite index key of digital contents metadata, comprising a key_index_list(key_index_list) section containing the multi-key data used in the composite index key search, wherein the multi-key data is encoded with a single code value.
